(19) United States
(12) Patent Application Publication
(10) Pub. No.: US 2011/0075761 A1
(43) Pub. Date: Mar. 31, 2011

(54) DIFFERENTIAL SIGNAL TRANSMISSION SYSTEM AND METHOD

(75) Inventor: Naoki Kuwata, Kawasaki (JP)

(73) Assignee: FUJITSU LIMITED, Kawasaki-shi (JP)

(21) Appl. No.: 12/889,838

(22) Filed: Sep. 24, 2010

(30) Foreign Application Priority Data
Sep. 28, 2009 (JP) 2009-222396

(51) Int. Cl. H04L 25/49; H04L 27/00

(52) U.S. Cl. 375/296; 375/295

(57) ABSTRACT

A transmission system for transmitting a first differential signal includes a transmitter, a transmission path, and a receiver. The transmitter transmits the first differential signal and a second differential signal. The transmission path transfers the first differential signal and the second differential signal. The receiver receives the first differential signal and the second differential signal. The transmitter includes a generator circuit and a switch. The generator circuit generates the second differential signal lower in baud rate than the first differential signal. The switch selects between the second differential signal and the first differential signal to output the selected differential signal to the transmission path. The receiver includes a detector circuit and a corrector circuit. The detector circuit detects a skew of the second differential signal. The corrector circuit corrects a skew of the first differential signal based by the detected skew of the second differential signal.

### CROSS-REFERENCE TO RELATED APPLICATIONS

This application is based upon and claims the benefit of priority of the prior Japanese Patent Application No. 2009-222396, filed on Sep. 28, 2009, the entire contents of which are incorporated herein by reference.

### FIELD

The present invention relates to a transmission system and method of transmitting a differential signal.

### BACKGROUND

A bit rate (speed) between boards is increased in an information processing apparatus such as a server system as a processing speed of a central processing unit (CPU) increases. A differential signal, having advantages such as noise immunity or low radiation of electro-magnetic interference (EMI), is used in the information processing apparatus that exchanges an electrical signal at a high-speed communication (Refer to Japanese Laid-open Patent Publication No. 10-303708).

Differential signals include two signals, i.e., a positive-side signal and a negative-side signal. Depending on variations in manufacturing accuracy of a printed circuit, and variations in material, a delay time difference takes place between two transmission lines. The delay time difference between the two transmission lines is not so problematic when the bit rate is low. The higher the bit rate, the more severe the waveform distortion of a transmission signal becomes.

In particular, if a high-speed transmission of 20 gigabits per second (Gb/s) or higher is performed, a time width of a signal waveform becomes short, and a delay time difference in excess of 1 unit interval (UI: one period of a bit clock) can take place over a travel distance of about tens of centimeters over a printed board. As a result, a margin of the time delay difference between the differential signals is reduced, and it is difficult to receive correctly a data signal. As a preventive step, a technique of detecting and then compensating for a skew of the differential signals on the receiver is used.

If the delay time difference is large between the transmission paths for transferring the differential signals in the above-described related art, it is difficult to maintain a differential state between the differential signals received by the receiver. It is thus difficult to detect the skew (phase difference) of the differential signals. The compensation for the skew of the differential signals is thus difficult, and an erratic operation may take place in a subsequent circuit of the receiver.

### SUMMARY

According to an aspect of the invention, a transmission system for transmitting a first differential signal includes a transmitter, a transmission path, and a receiver. The transmitter transmits the first differential signal and a second differential signal. The transmission path transfers the first differential signal and the second differential signal transmitted by the transmitter. The receiver receives the first differential signal and the second differential signal having transferred through the transmission path. The transmitter includes a generator circuit and a switch. The generator circuit generates the second differential signal lower in baud rate than the first differential signal. The switch selects between the second differential signal generated by the generator circuit and the first differential signal to output the selected differential signal to the transmission path. The receiver includes a detector circuit and a corrector circuit. The detector circuit detects a skew of the second differential signal transmitted by the transmitter and transferred through the transmission path. The corrector circuit corrects a skew of the first differential signal transmitted by the transmitter and transferred through the transmission path, based on the skew detected by the detector circuit.

The object and advantages of the invention will be realized and attained by the elements, features, and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an exemplary transmission system of a first embodiment;

FIG. 2 illustrates an example of differential signal to be transmitted by a transmitter;

FIG. 3A illustrates an example of the differential signal (Δt=0.3) received by a receiver;

FIG. 3B illustrates an example of the differential signal (Δt=0.6) received by the receiver;

FIG. 3C illustrates an example of the differential signal (Δt=0.8) received by the receiver;

FIG. 4A illustrates an example of waveform of the differential signals without skew;

FIG. 4B illustrates an example of the waveform of the differential signals with skew;

FIG. 4C illustrates an example of the waveform of a skew detection signal;

FIG. 5 is a graph illustrating an exemplary relationship between a bit rate of the skew detection signal and UI;

FIG. 6 is a flowchart illustrating an exemplary operation of the transmitter according to the first embodiment;

FIG. 7 is a flowchart illustrating an exemplary operation of the receiver according to the first embodiment;

FIG. 8 is a block diagram illustrating an exemplary structure of a transmission system according to a second embodiment;

FIG. 9 is a flowchart illustrating an exemplary operation of a transmitter according to the second embodiment;

FIG. 10 is a flowchart illustrating an exemplary operation of a receiver according to the second embodiment;

FIG. 11 is a block diagram illustrating an exemplary structure of a transmission system according to a third embodiment;

FIG. 12 is a flowchart illustrating an exemplary operation of a transmitter according to the third embodiment;

FIG. 13 is a flowchart illustrating an exemplary operation of a receiver according to the third embodiment;

FIG. 14 is a sequence chart illustrating an exemplary operation of the transmission system according to the third embodiment;

FIG. 15 is a block diagram illustrating an exemplary structure of a transmission system according to a fourth embodiment;

FIG. 16 is a flowchart illustrating an exemplary operation of a transmitter according to the fourth embodiment;

FIG. 17 is a flowchart illustrating an exemplary operation of a receiver according to the fourth embodiment;

FIG. 18 is a sequence chart illustrating an exemplary operation of the transmission system according to the fourth embodiment;

FIG. 19 is a block diagram illustrating an exemplary structure of a transmission system according to a fifth embodiment;

FIG. 20 is a flowchart illustrating an exemplary operation of a transmitter according to the fifth embodiment;

FIG. 21 is a flowchart illustrating an exemplary operation of a receiver according to the fifth embodiment; and

FIG. 22 is a sequence chart illustrating an exemplary operation of the transmission system according to the fifth embodiment.

### DESCRIPTION OF EMBODIMENTS

Referring to the drawings, transmission systems and transmission methods according to the embodiments are described in detail below. In accordance with the transmission systems and the transmission methods discussed herein, a differential signal from a transmitter is switched from a data signal to a signal lower in a bit rate than the data signal. In accordance with the transmission systems and the transmission methods discussed herein, a differential state is maintained between the differential signals received by the receiver even if a large delay time difference takes place between transmission lines transferring the differential signals. In accordance with the transmission systems and the transmission methods discussed herein, a skew of the differential signal is accurately detected.

### First Embodiment

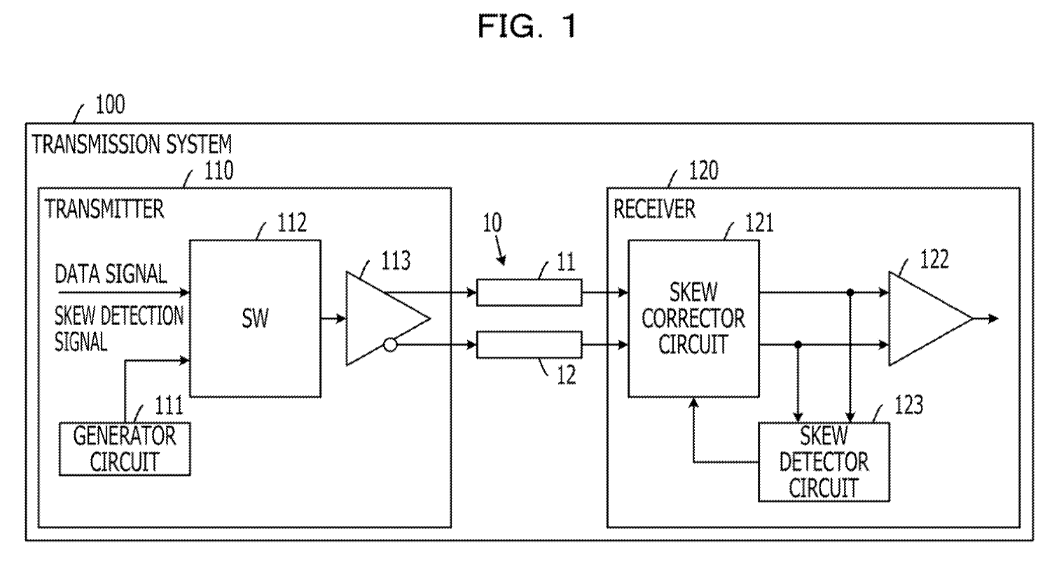

FIG. 1 is a block diagram illustrating an exemplary transmission system of a first embodiment. Referring to FIG. 1, a transmission system 100 of the first embodiment includes a transmission line 10, a transmitter 110, and a receiver 120. The transmission system 100 transmits a data signal (first differential signal) from the transmitter 110 to the receiver 120 via the transmission path 10. The transmission system 100 is an information processing apparatus such as a server system.

The transmission line 10 is a transmission path that permits the differential signals (electrical signal) to transfer therethrough. The transmission line 10 includes a positive-side transmission path 11 for transferring a positive-side signal of the differential signals and a negative-side transmission path 12 for transferring a negative-side signal of the differential signals. The transmission path 10 is preferably constructed such that the positive-side transmission path 11 and the negative-side transmission path 12 are approximately equal to each other in path length.

The transmitter 110 includes a generator circuit 111, a switch (SW) 112, and a differential output circuit 113. The generator circuit 111 generates a skew detection signal (second differential signal) as a differential signal lower in baud rate (bit rate) than the data signal to be transmitted from the transmitter 110 to the receiver 120. The skew detection signal may be a signal having a particular pattern or an alternating signal (clock signal). The baud rate of the skew detection signal is low to the extent that 1 UI of the skew detection signal is larger than a permissible skew. The permissible skew is a skew quantity that can be detected by a skew detector circuit 123.

The generator circuit 111 sets a speed B1 of the skew detection signal to be B0/n (n=2, 3, 4, . . . ) where B0 is a speed of the data signal (bit rate). The generator circuit 111 may set a speed B1 of the skew detection signal to be B0/2n (n=1, 2, 3, 4, . . . ). Since the speed (bit rate) of the skew detection signal may be set in accordance with the bit rate of the transmitter 110, a structure of the generator circuit 111 generating the skew detection signal may be simplified. The generator circuit 111 outputs the generated skew detection signal to the switch 112.

The switch 112 receives the skew detection signal from the generator circuit 111 and the data signal the transmitter 110 transmits to the receiver 120. The switch 112 switches between the skew detection signal and the data signal and outputs the selected signal. The differential signal output by the switch 112 is differentially amplified by the differential output circuit 113 and then output to the transmission line 10. The differential signal input to the transmission line 10 is transferred through the transmission line 10 to the receiver 120.

The switching of the switch 112 is controlled by a control circuit of the transmitter 110. Alternatively, the switching of the switch 112 may be controlled by a control circuit of the transmission system 100. The control circuits of the transmitter 110 and the transmission system 100 may be constructed of a processing circuit such as a digital signal processor (DSP).

The receiver 120 includes a skew corrector circuit 121, a differential circuit 122, and a skew detector circuit 123. The skew corrector circuit 121 sets a skew correction value based on the skew of which detector circuit 123 has notified the skew corrector circuit 121. In response to the set skew correction value, the skew corrector circuit 121 corrects the skew of the differential signal transferred by the transmission line 10. For example, the skew corrector circuit 121 varies a delay time difference between a positive-side signal and a negative-side signal of the differential signal transferred by the transmission line 10, in accordance with the set skew correction value, and outputs the negative-side signal and the positive-side signal with the delay time difference thereof varied.

The differential circuit 122 performs a differential process on the differential signal output by the skew corrector circuit 121. The skew detector circuit 123 acquires the differential signal output from the skew corrector circuit 121 to the differential circuit 122 and detects a skew of the acquired differential signal. The skew detector circuit 123 notifies the skew corrector circuit 121 of the detected skew.

With the above-described arrangement, the transmitter 110 switches the switch 112 to transmit the skew detection signal to the receiver 120, and the skew detector circuit 123 in the receiver 120 detects the skew of the skew detection signal. In response to the skew detected by the skew detector circuit 123, the skew corrector circuit 121 sets the skew correction value. The transmitter 110 further switches the switch 112, thereby transmitting the data signal to the receiver 120. The skew corrector circuit 121 in the receiver 120 corrects the skew of the data signal in accordance with the set skew correction value.

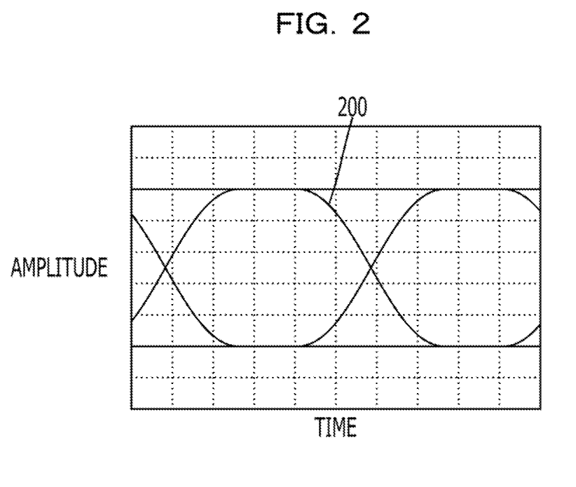

FIG. 2 illustrates an example of the differential signal transmitted by the transmitter 110. In FIG. 2, the abscissa represents time, while the ordinate represents amplitude. An eye pattern 200 in FIG. 2 represents the differential signal input to the transmission line 10 from the transmitter 110. As illustrated in the eye pattern 200, the differential signal input to the transmission line 10 from the transmitter 110 is substantially free from wave degradation.

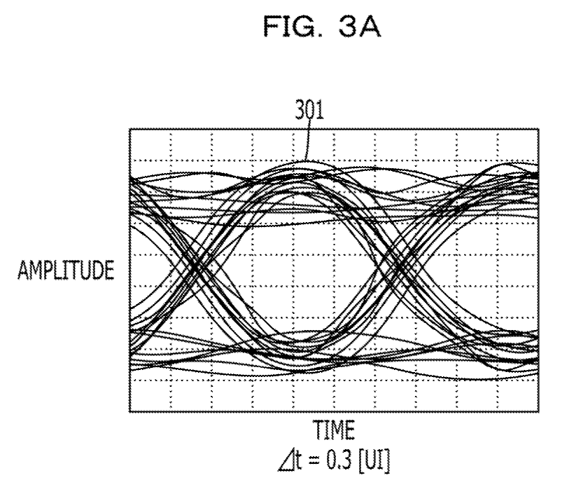

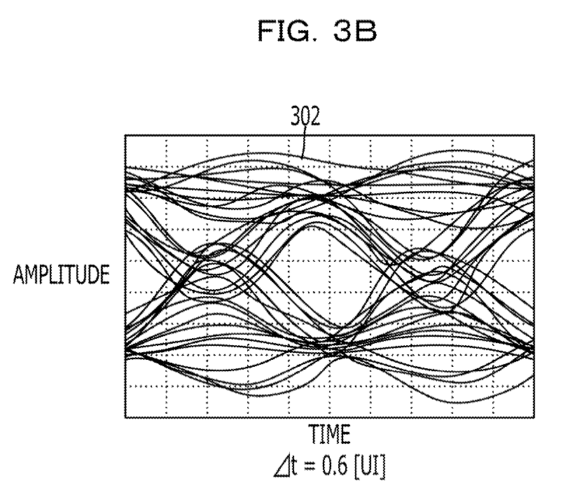

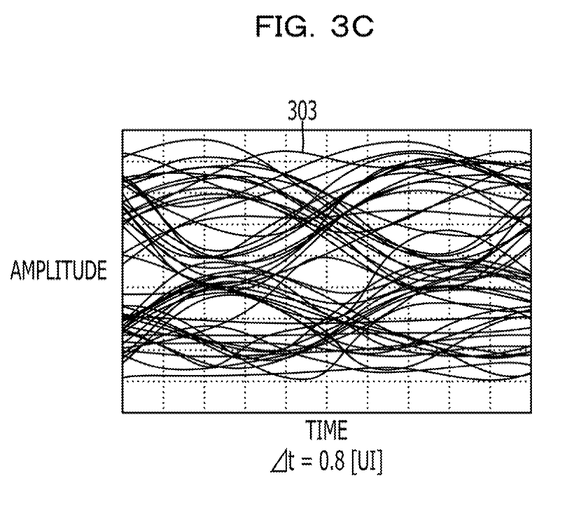

FIG. 3A illustrates an exemplary differential signal (Δt=0.3) received by the receiver 120. FIG. 3B illustrates an exemplary differential signal (Δt=0.6) received by the receiver 120. FIG. 3C illustrates an exemplary differential signal (Δt=0.8) received by the receiver 120. As illustrated in FIGS. 3A-3C, the abscissa represents time while the ordinate represents amplitude.

Eye patterns 301-303 illustrated in FIGS. 3A-3C represent the differential signals received by the receiver 120 when the delay time differences Δt of the differential signals transferred through the transmission line 10 are 0.3 UI, 0.6 UI, and 0.8 UI. The delay time difference Δt is |tp-tn| where tp represents a delay time of the positive-side signal along the positive-side transmission path 11 and to represents a delay time of the negative-side signal along the negative-side transmission path 12.

The waveform of the differential signals received by the receiver 120 becomes distorted as illustrated in the eye patterns 301-303 as the delay time difference Δt is large. If the rate of the differential signal is high (for example, as high as 20 Gb/s), the time of 1 UI of the differential signal becomes short. The delay time difference Δt becomes relatively large with respect to 1 UI of the differential signal.

For example, if a bit rate of the differential signal illustrated in the eye pattern 301 is doubled (for example, from 20 Gb/s to 40 Gb/s), the delay time difference Δt increases from 0.3 UI to 0.6 UI. The differential signals illustrated in the eye pattern 302 substantially result. The higher the bit rate of the differential signal, the larger the delay time difference Δt relatively becomes.

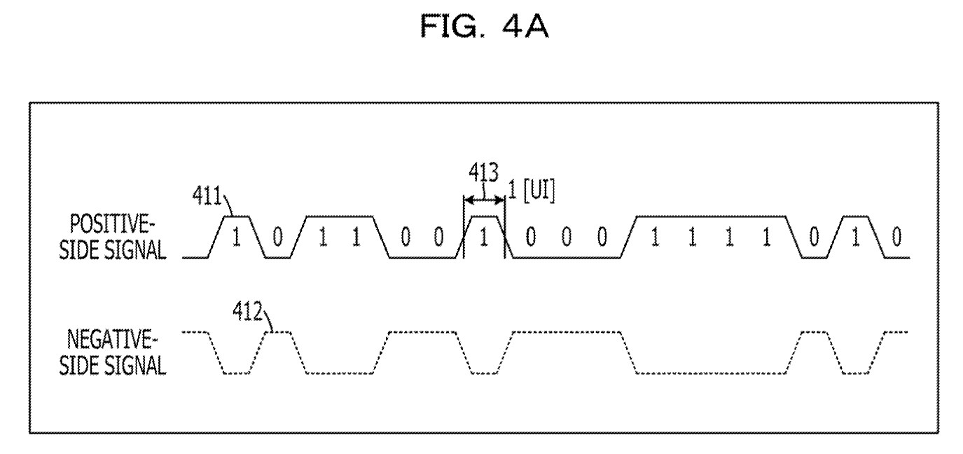

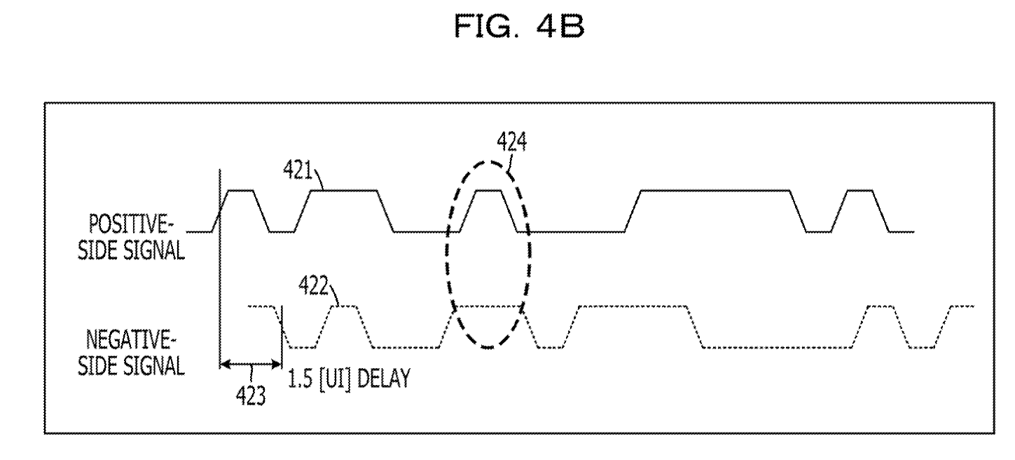

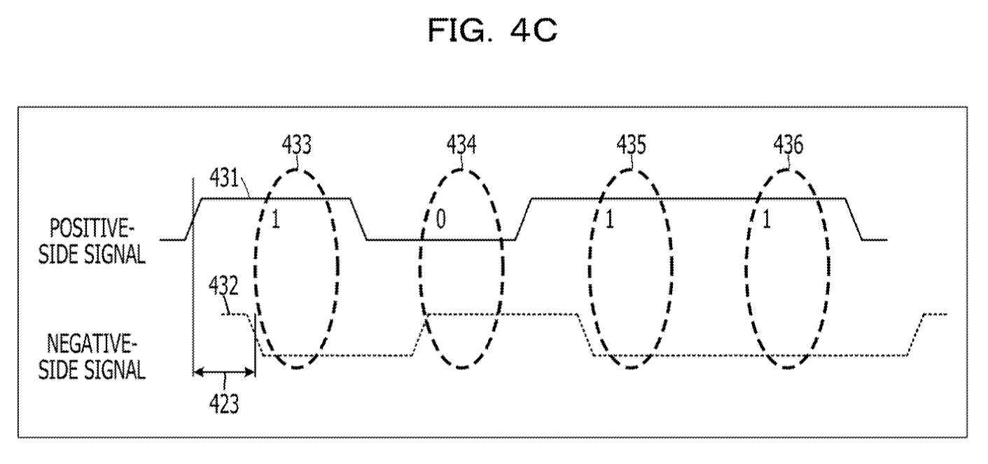

FIG. 4A illustrates an example of waveforms of the differential signals free from skewing. A positive-side signal 411 and a negative-side signal 412 in FIG. 4A are respectively a positive-side signal and a negative-side signal of the differential signals free from skewing. A pattern of the positive-side signal 411 is “10110010001111010” and a pattern of the negative-side signal 412 is “01001101110000101.” A duration 413 indicates 1 UI of the differential signal.

If no large skew is present between the differential signals, a differential state is established between the differential signals. For example, a differential state is established between the positive-side signal 411 and the negative-side signal 412 at all the bits thereof. The differential circuit 122 thus operates normally. Also, if no large skew is present between the differential signals, a differential state is largely maintained between the differential signals. The skew detector circuit 123 may detect a skew between the differential signals.

FIG. 4B illustrates an example of waveforms of the differential signals suffering from skewing. A positive-side signal 421 and a negative-side signal 422 are those of the differential signals suffering from a large skew. More specifically, a skew 423 shows that the negative-side signal 422 is delayed from the positive-side signal 421 by 1.5 UI. In a portion of the waveform diagram labeled number 424, both the positive-side signal 421 and the negative-side signal 422 are at a high level (level 1), and the differential circuit 122 fails to operate normally. The skew detector circuit 123 has difficulty detecting the skew between the differential signals.

FIG. 4C illustrates an example of waveforms of skew detection signals. A positive-side signal 431 and a negative-side signal 432 in FIG. 4C are those of the differential signals having one-quarter the bit rate of the differential signals illustrated in FIGS. 4A and 4B. The positive-side signal 431 and the negative-side signal 432 may have the same size of skew (skew 423) as that of the positive-side signal 421 and the negative-side signal 422 illustrated in FIG. 4B.

The skew 423 is smaller than 1 UI occurring between the positive-side signal 431 and the negative-side signal 432. As reference numbers 433-436 represent, a differential state is maintained between the positive-side signal 431 and the negative-side signal 432 at the bits thereof. The skew detector circuit 123 may thus detect the created skew.

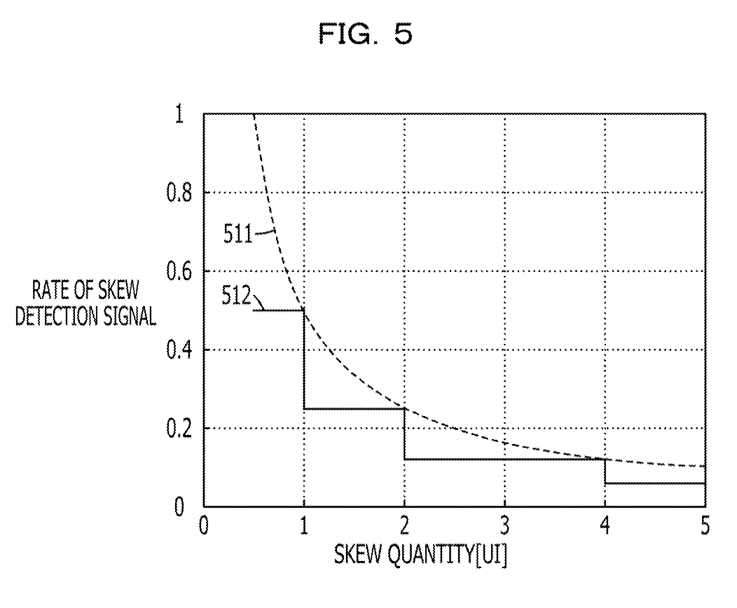

FIG. 5 is a graph illustrating an exemplary relationship between a bit rate of the skew detection signal and UI. Referring to FIG. 5, the abscissa represents a skew quantity occurring between the differential signals along the transmission line 10, and the ordinate represents a bit rate (baud rate) of the skew detection signal. The bit rate represented by the ordinate is a bit rate of the skew detection signal, generated by the generator circuit 111, and rated on a scale of 1 as being the bit rate of the data signal.

The bit rate of the skew detection signal generated by the generator circuit 111 is determined based on the skew quantity between the differential signals caused along the transmission line 10. A curve 511 illustrates a relationship established between the skew quantity of the differential signals caused along the transmission line 10 and a maximum bit rate of the skew detection signal if the skew quantity of the differential signals received by the receiver 120 is restricted to 0.5 UI or below.

A stepped curve 512 illustrates a relationship between the skew quantity and the maximum bit rate established when the bit rate of the skew detection signal is set to be B0/2n (n=1, 2, 3, 4, . . . ) in the curve 511 (B0 is the bit rate of the data signal). The larger the skew amount between the differential signals along the transmission line 10, the lower the bit rate of the skew detection signal is preferably set. Even if a large skew is created between the differential signals, a created skew may be detected.

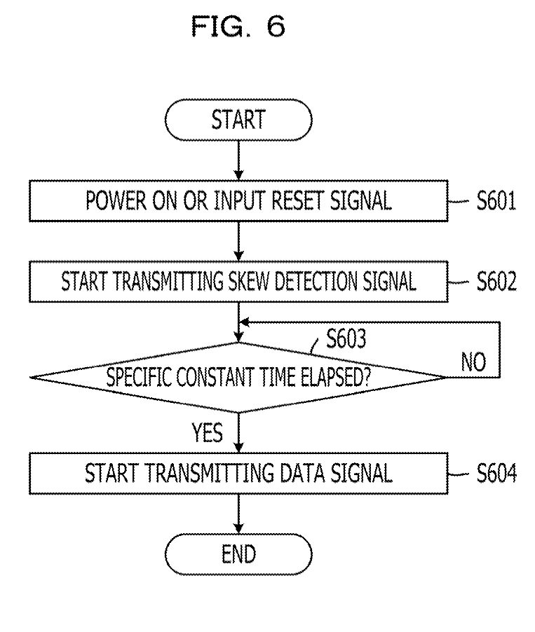

FIG. 6 is a flowchart illustrating an exemplary operation of the transmitter 110 of the first embodiment. When the transmitter 110 is powered on (or a reset signal is input to the transmitter 110) in step S601, the control circuit of the transmitter 110 switch-controls the switch 112 to start transmitting the skew detection signal (step S602). The control circuit determines whether a specified constant time has elapsed since the start of the transmission of the skew detection signal in step S602 (step S603). If the specified constant time has not elapsed, the control circuit waits on standby until the specified constant time has elapsed (no branch from step S603).

If the specified constant time has elapsed (yes branch from step S603), the control circuit switch-controls the switch 112 to start transmitting the data signal (step S604). Processing thus ends. For the specified constant time from the power-on or resetting, the skew detection signal is transmitted. After the elapse of the specified constant time, the data signal is transmitted.

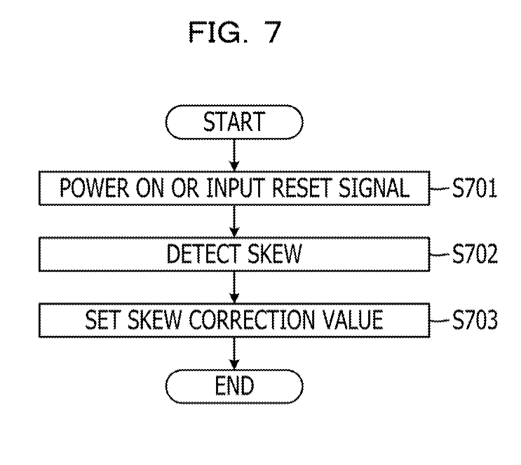

FIG. 7 is a flowchart of an exemplary operation of the receiver 120 of the first embodiment. The receiver 120 is powered on (or a reset signal is input to the receiver 120) in step S701. The skew detector circuit 123 in the receiver 120 detects a skew of the skew detection signal transmitted by the transmitter 110 (step S702).

The skew corrector circuit 121 sets a skew correction value in response to the skew detected in step S702 (step S703). A series of process steps thus ends. The skew of the skew detection signal is thus detected, and the skew of the data signal from the transmitter 110 is corrected in response to the detected skew.

Referring again to FIG. 1, the transmission system 100 of the first embodiment switches the signal from the transmitter 110 from data signal to the skew detection signal lower in bit rate than the data signal. The differential state is maintained in the signals received by the receiver 120 even if a delay time difference Δt is created between the positive-side transmission path 11 and the negative-side transmission path 12 of the transmission line 10. The skew is accurately detected. The skew of the data signal is corrected by the skew correction value set based on the detected skew. The skew of the data signal is thus accurately compensated for.

Even if the data signal is high in bit rate, the skew of the data signal is accurately compensated for. For example, the data signal may be as high as 20 Gb/s or 40 Gb/s, and the delay time difference Δt may be 1 UI or larger between the positive-side transmission path 11 and the negative-side transmission path 12 of the transmission line 10. Even under this condition, the skew of the data signal can be accurately compensated for. For example, high-rate differential signals can be transmitted in a backplane transfer within a server system even if the transmission lines of the differential signals fail to be accurately the same length over a backplane.

For the specified constant time from the power-on or resetting, the skew detection signal is transmitted. After the elapse of the specified constant time, the data signal is transmitted. Before the transmission of the data signal, the skew is detected to set the skew correction value. The skew of the data signal is accurately compensated for from the start of the transmission of the data signal.

### Second Embodiment

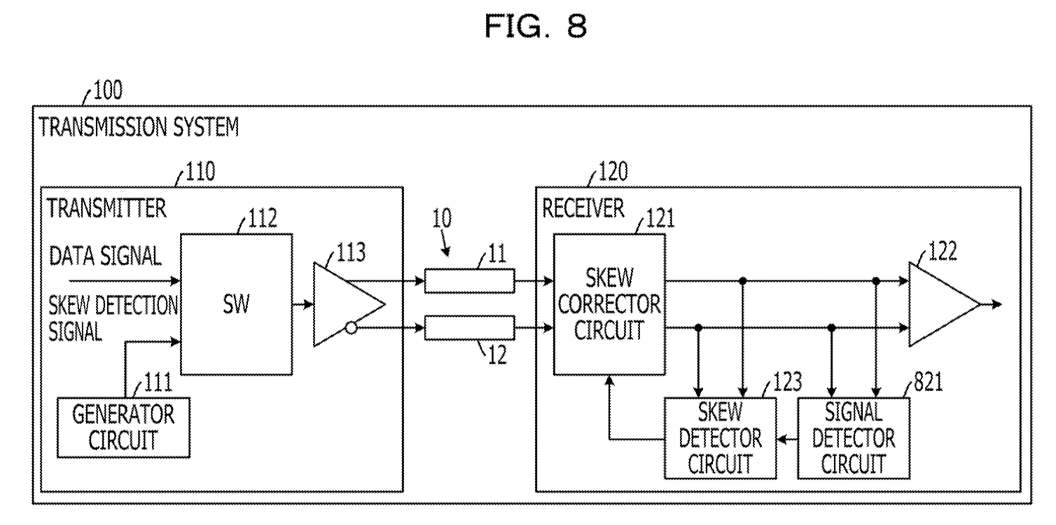

FIG. 8 is a block diagram illustrating an exemplary structure of a transmission system 100 of a second embodiment. Referring to FIG. 8, elements that may be substantially identical to those illustrated in FIG. 1 are designated with the same reference numerals, and the discussion thereof is omitted here. As illustrated in FIG. 8, the receiver 120 in the transmission system 100 includes a signal ditector circuit 821 in addition to the arrangement illustrated in FIG. 1.

The signal sensor circuit 821 senses the skew detection signal output by the transmitter 110. More specifically, the signal sensor circuit 821 acquires the differential signal output from the skew corrector circuit 121 to the differential circuit 122, and determines whether the acquired differential signal is a skew detection signal. If the acquired differential signal is a skew detection signal, the signal sensor circuit 821 outputs a sense signal to the skew detector circuit 123.

The signal sensor circuit 821 then measures a bit rate of the acquired differential signal, and determines whether the measured bit rate is lower than a specified threshold value. The specified threshold value is equal to or lower than the bit rate of the data signal and higher than the bit rate of the skew detection signal. If the measured bit rate is equal to or higher than the specified threshold value, the signal sensor circuit 821 determines that the differential signal is not a skew detection signal. If the measured bit rate is lower than the specified threshold value, the signal sensor circuit 821 determines that the differential signal is a skew detection signal.

Alternatively, the signal sensor circuit 821 may measure the bit rate of the acquired differential signal, and determine whether an amount of change in the measured bit rate is equal to or higher than a specified threshold value. If the amount of change in the measured bit rate is lower than the specified threshold value, the signal sensor circuit 821 determines that the differential signal is not a skew detection signal. If the amount of change in the measured bit rate is equal to or higher than the specified threshold value, the signal sensor circuit 821 determines that the differential signal is a skew detection signal.

Alternatively, the signal sensor circuit 821 may sense a pattern of the acquired differential signal (such as an alternating pattern), and determine whether the detected pattern is a specified pattern. The specified pattern is a pattern of the skew detection signal generated by the generator circuit 111. If the detected pattern is not the specified pattern, the signal sensor circuit 821 determines that the differential signal is not a skew detection signal. If the detected pattern is the specified pattern, the signal sensor circuit 821 determines that the differential signal is a skew detection signal.

The skew detector circuit 123 does not detect the skew of the differential signal until the sense signal is output from the signal sensor circuit 821. Δt the moment (or after) the signal sensor circuit 821 outputs the sense signal, the skew detector circuit 123 detects the skew of the differential signal. Alternatively, even if the skew detector circuit 123 has detected a skew of the differential signal, the skew detector circuit 123 may not notify the skew corrector circuit 121 of the detected skew until the sense signal is output. After the sense signal is output, the skew detector circuit 123 may notify the skew corrector circuit 121 of the detected skew.

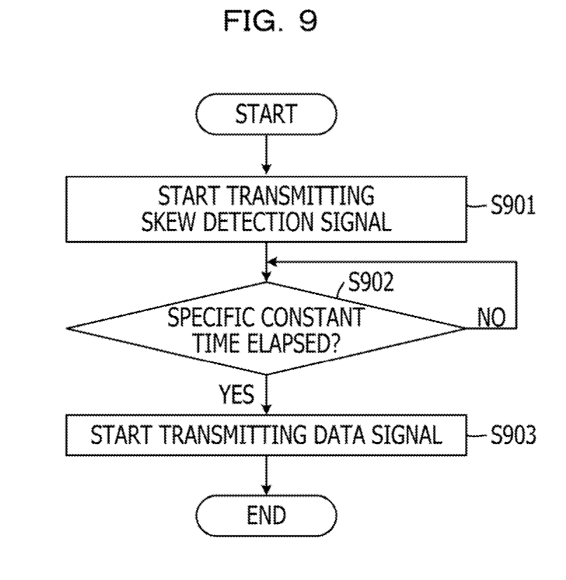

FIG. 9 is a flowchart illustrating an exemplary operation of the transmitter 110 of the second embodiment. The control circuit of the transmitter 110 switch-controls the switch 112 to start transmitting the skew detection signal (step S901). Step S901 may be performed at the timing of power-on or resetting of the transmitter 110, or at the timing at which a user enters a command. Steps S902 and S903 may be respectively substantially identical to steps S603 and S604 illustrated in FIG. 6, and the discussion thereof is omitted herein. With this arrangement, the skew detection signal is transmitted for a specified constant time from the specified timing, and the data signal is then transmitted after an elapse of the specified constant time.

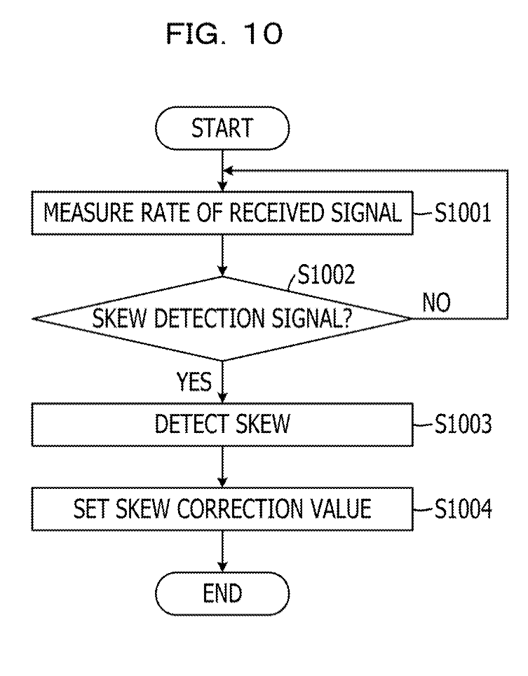

FIG. 10 is a flowchart illustrating an exemplary operation of the receiver 120 of the second embodiment. The signal sensor circuit 821 in the receiver 120 measures the bit rate of the signal received from the transmitter 110 (step S1001). In response to the bit rate measured in step S1001, the signal sensor circuit 821 determines whether the signal received from the transmitter 110 is a skew detection signal (step S1002).

If it is determined in step S1002 that the received signal is not a skew detection signal (no branch from step S1002), processing returns to step S1001. If the received signal is a skew detection signal (yes branch from step S1002), the skew detector circuit 123 detects a skew of the skew detection signal (step S1003).

The skew corrector circuit 121 sets the skew correction value in response to the skew detected in step S1003 (step S1004). Step S1004 completes a series of process steps. The skew detection signal transmitted from the transmitter 110 is thus detected. When the skew detection signal is sensed, the skew of the skew detection signal may also be detected.

In the transmission system 100 of the second embodiment as illustrated in FIG. 8, the receiver 120 senses the skew detection signal transmitted from the transmitter 110, and detects the skew of the skew detection signal after sensing the skew detection signal. The transmitter 110 may transmit the skew detection signal at any time, and the receiver 120 may detect the skew of the skew detection signal.

The skew of the skew detection signal may not be detect if the skew detection signal is not sensed. This arrangement prevents or at least inhibits the skew detector circuit 123 from detecting erratically the skew of the data signal, and prevents or at least reduces the skew corrector circuit 121 from malfunction.

### Third Embodiment

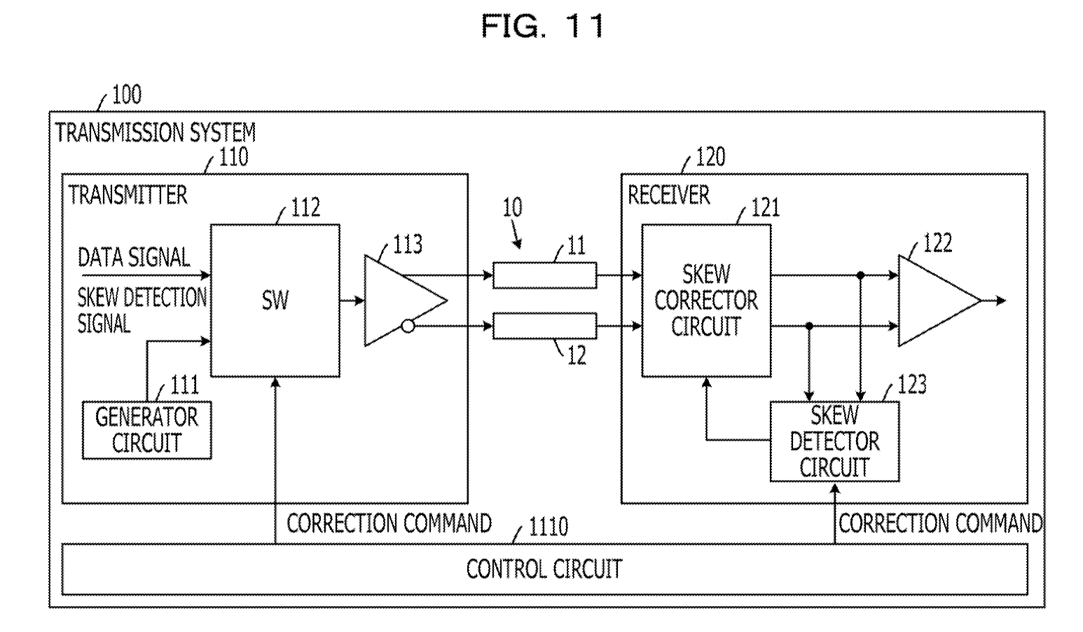

FIG. 11 is a block diagram illustrating an exemplary structure of a transmission system 100 of a third embodiment. Referring to FIG. 11, elements that may be substantially identical to those illustrated in FIG. 1 are designated with the same reference numerals and the discussion thereof is omitted here. Referring to FIG. 11, the transmission system 100 of the third embodiment includes a control circuit 1110 in addition to the structure of FIG. 1. The control circuit 1110 may be a processing circuit such as a digital signal processor (DSP). The control circuit 1110 may output concurrently a correction command to the transmitter 110 and the receiver 120 at the time of power-on or resetting of the transmitter 110, or at the time at which a user enters a command.

If no correction command is output from the control circuit 1110, the switch 112 in the transmitter 110 outputs the data signal. If a correction command is output from the control circuit 1110, the switch 112 in the transmitter 110 outputs the skew detection signal. If no correction command is output from the control circuit 1110, the skew detector circuit 123 in the receiver 120 detects no skew from the differential signal. If a correction command is output from the control circuit 1110, the skew detector circuit 123 in the receiver 120 detects a skew from the differential signal.

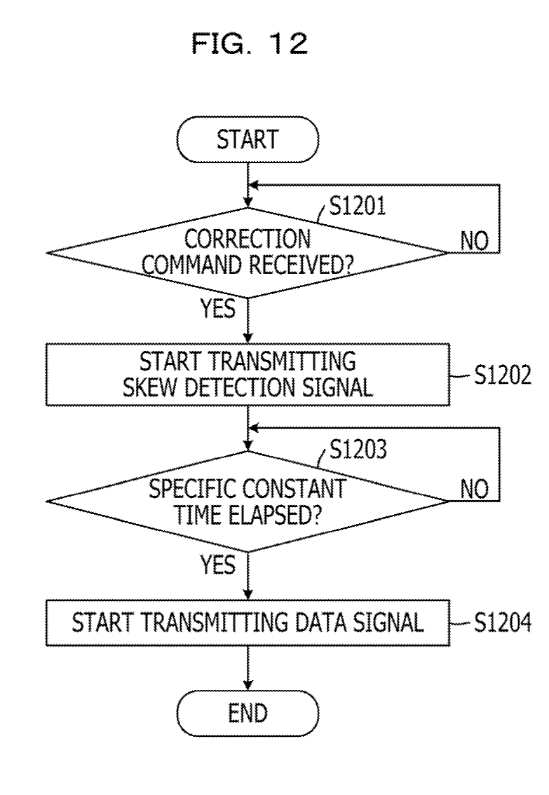

FIG. 12 is a flowchart illustrating an exemplary operation of the transmitter 110 of the third embodiment. The control circuit of the transmitter 110 determines during the transmission of the data signal whether a correction command has been received from the control circuit 1110 (step S1201). If no correction command has been received, the control circuit of the transmitter 110 waits on standby until a correction command has been received (no branch from step S1201).

If it is determined in step S1201 that a correction command has been received (yes branch from step S1201), processing proceeds to step S1202. Steps S1202-S1204 illustrated in FIG. 12 may be respectively substantially identical to steps S602-S604 illustrated in FIG. 6, and the discussion thereof is omitted here. If a correction command is output from the control circuit 1110, the skew detection signal is thus output.

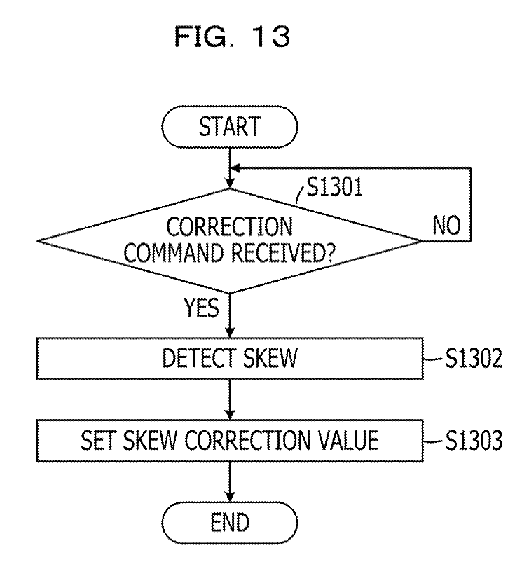

FIG. 13 is a flowchart illustrating an exemplary operation of the transmitter 110 of the third embodiment. The receiver 120 determines during the transmission of the data signal whether a correction signal has been received from the control circuit 1110 (step S1301). If no correction command has been received, the receiver 120 waits on standby until a correction command has been received (no branch from step S1301). Upon receiving a correction command (yes branch from step S1301), the receiver 120 proceeds to step S1302.

Steps S1302-S1303 illustrated in FIG. 13 may be respectively substantially identical to steps S702-S703 illustrated in FIG. 7, and the discussion thereof is omitted here. With this arrangement, a skew is detected from the skew detection signal if the correction command is output from the control circuit 1110.

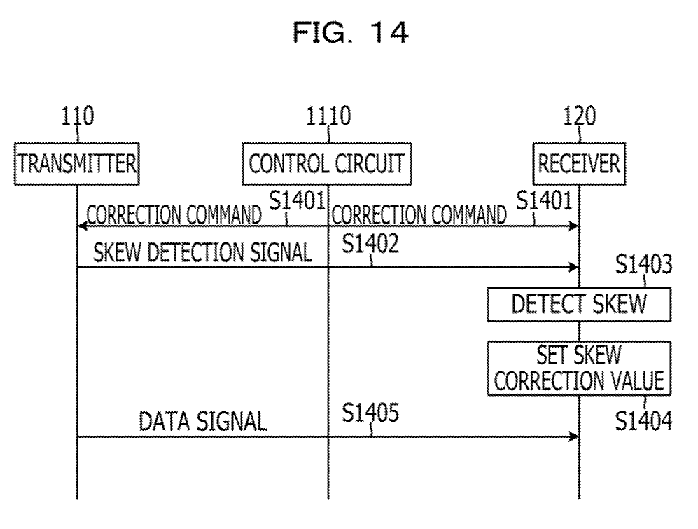

FIG. 14 is a sequence chart of an exemplary operation of the transmission system 100 of the third embodiment. The control circuit 1110 outputs a correction command to each of the transmitter 110 and the receiver 120 (step S1401). The transmitter 110 transmits the skew detection signal (step S1402). The receiver 120 detects the skew of the skew detection signal transmission-started in step S1402 (step S1403).

The receiver 120 sets the skew correction value based on the skew detected in step S1403 (step S1404). The transmitter 110 transmits the data signal (step S1405). A series of process steps are thus complete.

Referring again to FIG. 11, in the transmission system 100 of the third embodiment, the transmitter 110 outputs the skew detection signal in response to the correction command output from the control circuit 1110, and the receiver 120 detects the skew of the skew detection signal. The control circuit 1110 may transmit the correction command at any time, and the receiver 120 may detect the skew of the skew detection signal.

The skew of the skew detection signal may not be detected if the correction command is not output. This arrangement prevents or at least reduces the skew detector circuit 123 from detecting erratically the skew of the data signal, and prevents or at least inhibits the skew corrector circuit 121 from malfunction.

### Fourth Embodiment

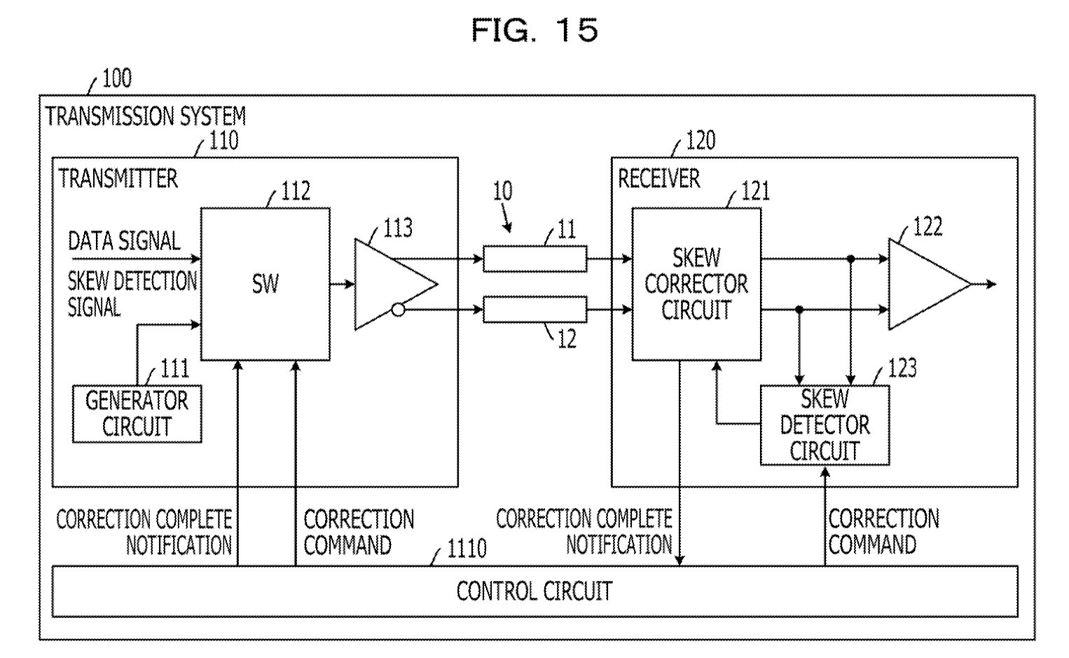

FIG. 15 is a block diagram illustrating an exemplary structure of a transmission system 100 of a fourth embodiment. Referring to FIG. 15, elements that may be substantially identical to those illustrated in FIG. 11 are designated with the same reference numerals and the discussion thereof is omitted here. Referring to FIG. 15, the skew corrector circuit 121 of the transmission system 100 of the fourth embodiment sets the skew correction value in response to the skew of which the skew detector circuit 123 has notified the skew corrector circuit 121, and outputs a correction complete notification to the control circuit 1110.

The control circuit 1110 outputs to the transmitter 110 the correction complete notification output by the receiver 120. If the control circuit 1110 outputs the correction complete notification, the switch 112 in the transmitter 110 outputs the data signal. Alternatively, the skew corrector circuit 121 may output directly the correction complete notification to the transmitter 110 rather than via the control circuit 1110.

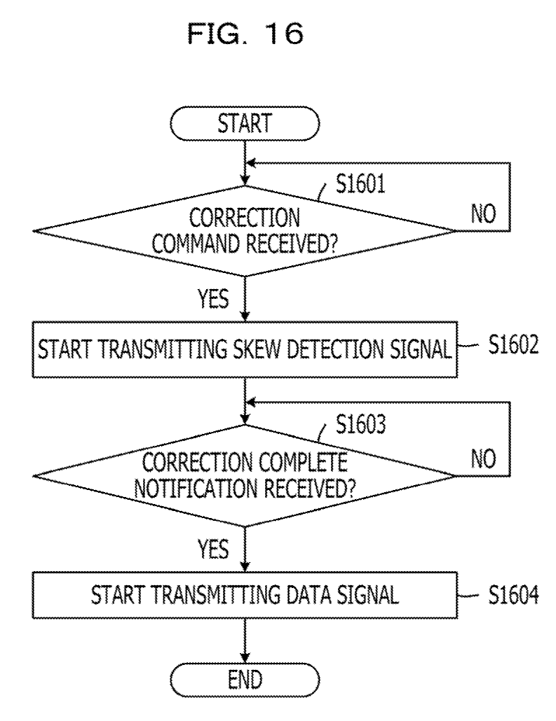

FIG. 16 is a flowchart illustrating an exemplary operation of the transmitter 110 of the fourth embodiment. Steps S1601 and S1602 illustrated in FIG. 16 may be respectively substantially identical to steps S1201 and S1202 illustrated in FIG. 12, and the discussion thereof is omitted here. When the transmission of the skew detection signal starts in step S1602, the control circuit of the transmitter 110 determines whether the correction complete notification has been received from the receiver 120 (step S1603). If no correction complete notification has been received, the control circuit of the transmitter 110 waits on standby until a correction complete notification has been received (no branch from step S1603).

If it is determined in step S1603 that a correction complete notification has been received (yes branch from step S1603), the control circuit of the transmitter 110 switch-controls the switch 112 to start transmitting the data signal (step S1604). A series of process steps are thus completed. The data signal is output when the correction complete notification is output from the receiver 120.

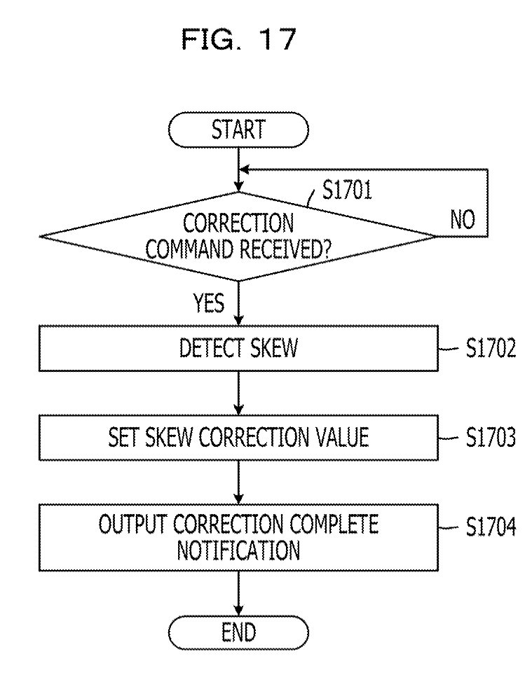

FIG. 17 is a flowchart illustrating an exemplary operation of the receiver 120 of the fourth embodiment. Steps S1701-S1703 illustrated in FIG. 17 may be respectively substantially identical to steps S1301-S1303 illustrated in FIG. 13, and the discussion thereof is omitted here. If the skew correction value is set in step S1703, the skew corrector circuit 121 outputs the correction complete notification to the transmitter 110 via the control circuit 1110 (step S1704). A series of process steps are thus complete. The correction complete notification is output to the transmitter 110 if the skew corrector circuit 121 sets the skew correction value.

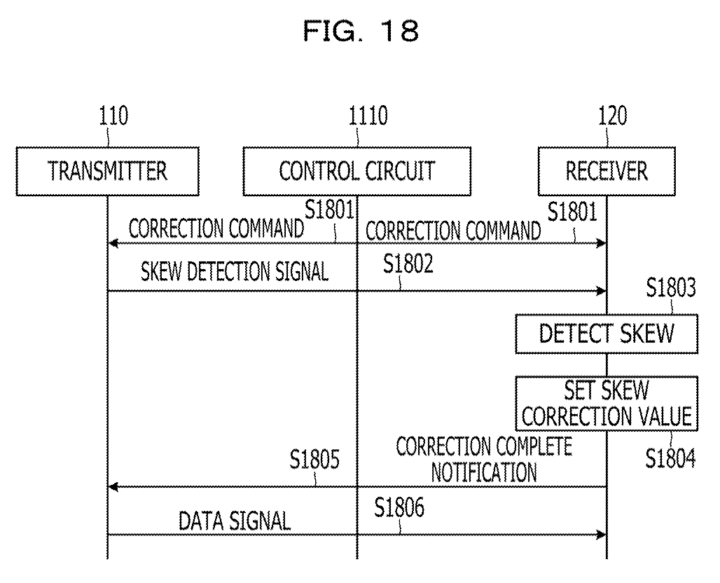

FIG. 18 is a sequence chart of an exemplary operation of the transmission system 100 of the fourth embodiment. Steps S1801-S1804 illustrated in FIG. 18 may be respectively substantially identical to steps S1401-S1404 as illustrated in FIG. 14, and the discussion thereof is omitted here. If the skew correction value is set in step S1804, the receiver 120 transmits the correction complete notification to the transmitter 110 (step S1805). The transmitter 110 then transmits the data signal (step S1806) and a series of process steps is thus complete.

Referring again to FIG. 15, in the transmission system 100 of the fourth embodiment, the correction complete notification is output to the transmitter 110 if the skew correction value is set by the skew corrector circuit 121. The transmitter 110 then outputs the data signal. The transmission of the data signal starts when the receiver 120 sets the skew correction value. The skew of the data signal is accurately compensated for.

If the receiver 120 sets the skew correction value, the transmitter 110 may start transmitting the data signal without waiting until the elapse of the specified constant time. The period of time throughout which the skew detection signal is transmitted is reduced in this way, and the transmission efficiency of the data signal is increased.

### Fifth Embodiment

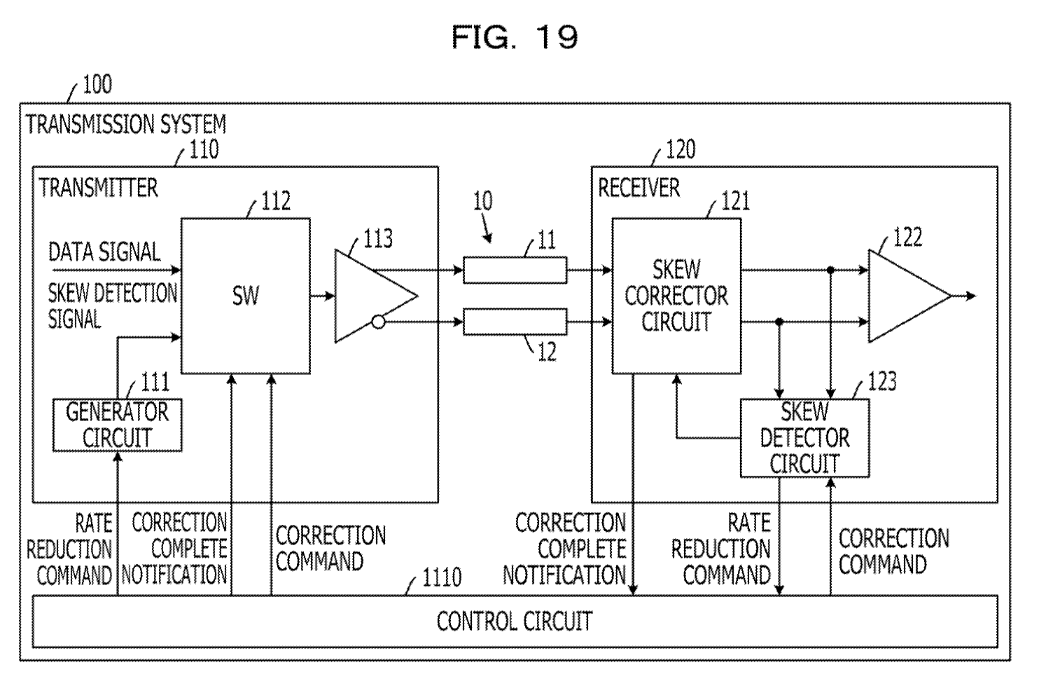

FIG. 19 is a block diagram of a transmission system 100 of a fifth embodiment. Referring to FIG. 19, elements that may be substantially identical to those illustrated in FIG. 15 are designated with the same reference numerals and the discussion thereof is omitted here. As illustrated in FIG. 19, the skew detector circuit 123 in the transmission system 100 of the fifth embodiment outputs a rate reduction command to the control circuit 1110 if the skew of the differential signal has not been detected.

The control circuit 1110 outputs to the transmitter 110 the rate reduction command output by the receiver 120. If the control circuit 1110 outputs the rate reduction command, the generator circuit 111 in the transmitter 110 reduces the bit rate of the skew detection signal generated thereby. It is noted that the skew detector circuit 123 can directly output the rate reduction command to the transmitter 110 rather than via the control circuit 1110.

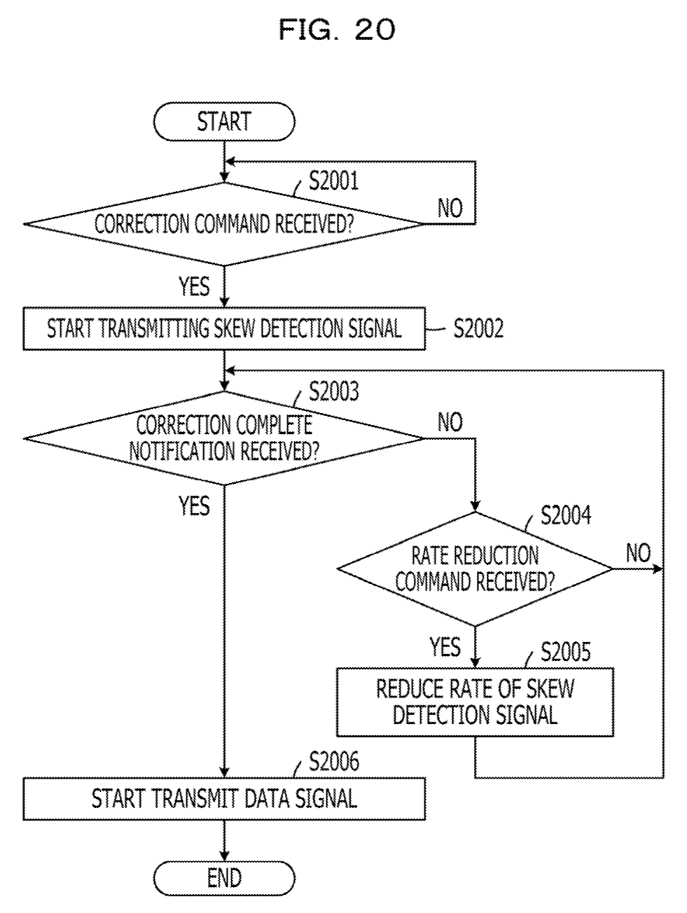

FIG. 20 is a flowchart illustrating an exemplary operation of the transmitter 110 of the fifth embodiment. Steps S2001-S2003 illustrated in FIG. 20 may be respectively substantially identical to steps S1601-S1603 illustrated in FIG. 16, and the discussion thereof is omitted here. If no correction complete notification has been received in step S2003 (no branch from step S2003), the control circuit of the transmitter 110 determines whether a rate reduction command has been received from the receiver 120 (step S2004).

If it is determined in step S2004 that no rate reduction command has been received from the receiver 120 (no branch from step S2004), processing returns to step S2003. If a rate reduction command has been received (yes branch from step S2004), the generator circuit 111 reduces the bit rate of the skew detection signal generated thereby (step S2005). Processing returns to step S2003.

If it is determined in step S2003 that a rate reduction command has been received (yes branch from step S2003), the control circuit switch-controls the switch 112 to transmit the data signal (step S2006). A series of process steps are thus complete. The bit rate of the skew detection signal is reduced if the rate reduction command is output from the receiver 120.

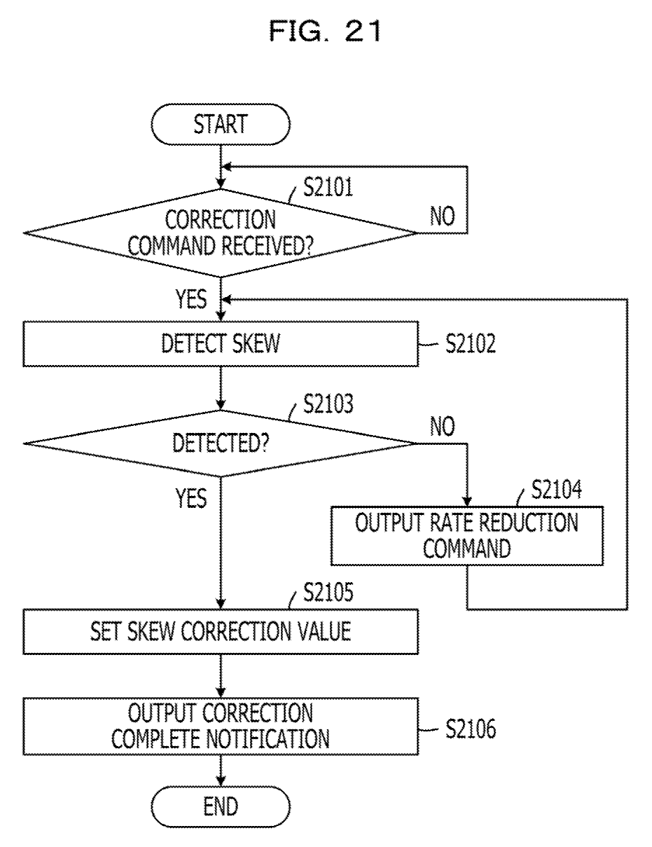

FIG. 21 is a flowchart illustrating an exemplary operation of the receiver 120 of the fifth embodiment. Steps S2101 and S2102 illustrated in FIG. 21 may be respectively substantially identical to steps S1701 and S1702 illustrated in FIG. 17, and the discussion thereof is omitted here. The control circuit of the transmitter 120 determines whether a skew has been detected in step S2102 (step S2103). If no skew has been detected (no branch from step S2103), the skew detector circuit 123 outputs the rate reduction command to the transmitter 110 (step S2104). Processing then returns to step S2102.

If it is determined in step S2103 that a skew has been detected (yes branch from step S2103), processing proceeds to step S2105. Steps S2105 and S2106 illustrated in FIG. 21 may be respectively substantially identical to steps S1703 and S1704 illustrated in FIG. 17, and the discussion thereof is omitted here. The rate reduction command can be output to the transmitter 110 in this way if no skew has been detected by the skew detector circuit 123.

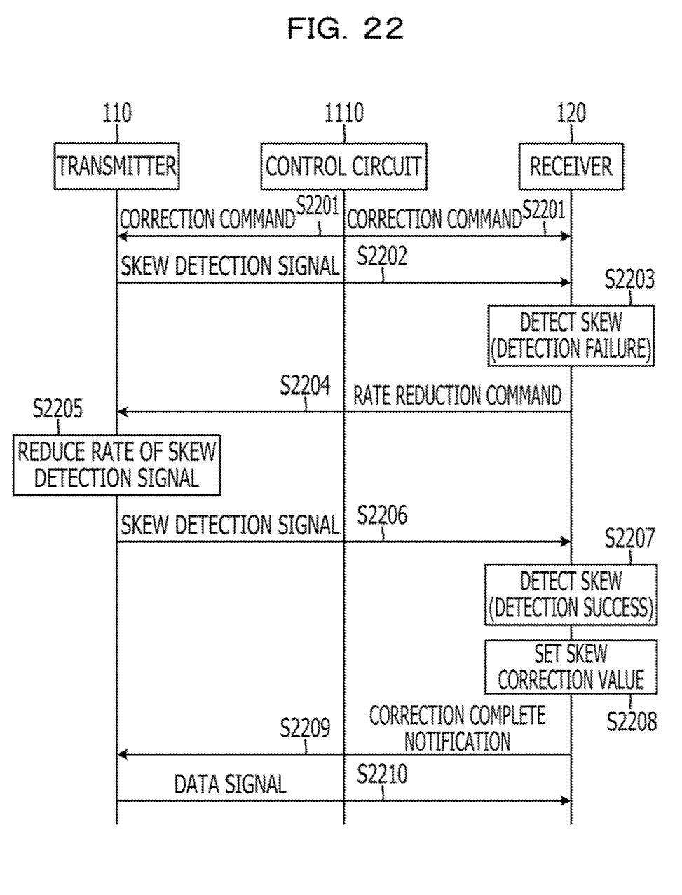

FIG. 22 is a sequence chart illustrating an exemplary operation of the transmission system 100 of the fifth embodiment. Steps S2201-S2203 illustrated in FIG. 22 may be respectively substantially identical to steps S1801-S1803 illustrated in FIG. 18, and the discussion thereof is omitted here. However, it is presumed in this case that the receiver 120 fails to detect a skew in step S2203 (detection failure).

The receiver 120 outputs the rate reduction command to the transmitter 110 (step S2204). The transmitter 110 reduces the bit rate of the skew detection signal to be generated (step S2205), and outputs the skew detection signal with the bit rate thereof reduced (step S2206). The receiver 120 then detects the skew of the skew detection signal transmission in step S2206 (step S2207).

It is assumed that a skew has been detected in step S2207 (detection success). The receiver 120 sets the skew correction value based on the skew detected in step S2207 (step S2208). Steps S2209 and S2210 illustrated in FIG. 22 may be respectively substantially identical to steps S1805 and S1806 illustrated in FIG. 18, and the discussion thereof is omitted here.

Referring again to FIG. 19, if the skew detector circuit 123 fails to detect a skew in the transmission system 100 of the fifth embodiment, the receiver 120 transmits the rate reduction command to the transmitter 110 to reduce the bit rate of the skew detection signal. The bit rate of the skew detection signal may be automatically reduced if the bit rate of the skew detection signal is not low enough. The skew of the data signal is accurately compensated for. Even if the bit rate of the data signal varies, the skew of the data signal may be accurately compensated for even by automatically reducing the bit rate of the skew detection signal.

In accordance with the transmission systems and the transmission methods as described above, the differential state is maintained between the received signals at the receiver by switching the signal from the transmitter from the data signal to the low bit rate signal even if a large delay time difference occurs between the transmission paths of the differential signals. The skew is accurately detected and corrected. The skew of the data signal is accurately compensated for. In addition the above-described embodiments, the following technique is also described.

The transmission system and the transmission method provide the advantage that the skew of the differential signals is accurately compensated for.

All examples and conditional language recited herein are intended for pedagogical purposes to aid the reader in understanding the invention and the concepts contributed by the inventor to furthering the art, and are to be construed as being without limitation to such specifically recited examples and conditions. Although the embodiments of the present invention have been described in detail, it should be understood that the various changes, substitutions, and alterations could be made hereto without departing from the spirit and scope of the invention.

What is claimed is:

1. A transmission system for transmitting a first differential signal, comprising:
a transmitter to transmit the first differential signal and a second differential signal;
a transmission path to transfer the first differential signal and the second differential signal transmitted by the transmitter; and
a receiver to receive the first differential signal and the second differential signal having transferred through the transmission path,
the transmitter including:
a generator circuit to generate the second differential signal lower in baud rate than the first differential signal; and
a switch to select between the second differential signal generated by the generator circuit and the first differential signal to output a selected differential signal to the transmission path; and
the receiver including:
a detector circuit to detect a skew of the second differential signal transmitted by the transmitter and transferred through the transmission path; and
a corrector circuit to correct a skew of the first differential signal transmitted by the transmitter and transferred through the transmission path, based on the skew detected by the detector circuit.

2. The transmission system according to claim 1, wherein the corrector circuit sets a correction value responsive to the skew detected by the detector circuit, and corrects the skew of the first differential signal in accordance with the set correction value.

3. The transmission system according to claim 2, wherein the receiver outputs a correction complete notification to the transmitter when the correction value is set by the corrector circuit, and
wherein the switch outputs the first differential signal when the receiver outputs the correction complete notification.

4. The transmission system according to claim 1, wherein the switch outputs the second differential signal for a specified constant time beginning with power-on of the transmitter.

5. The transmission system according to claim 1, wherein the switch outputs the second differential signal for a specified constant time beginning with resetting of the transmitter.

6. The transmission system according to claim 4, wherein the switch outputs the first differential signal after an elapse of the specified constant time.

7. The transmission system according to claim 1, wherein the receiver further comprises: a sensor circuit to sense the second differential signal transmitted by the transmitter and transferred through the transmission path, and
wherein the detector circuit detects the skew of the second differential signal when the sensor circuit senses the second differential signal.

8. The transmission system according to claim 1, wherein a rate of the differential signal transmitted by the transmitter and transferred through the transmission path is measured, and wherein a skew detection signal is detected based on the rate.

9. The transmission system according to claim 1, further comprising a control circuit for outputting concurrently a correction command to the transmitter and the receiver,
wherein the switch outputs the second differential signal when the correction command is output, and
wherein the detector circuit detects the skew of the second differential signal when the correction command is output.

10. The transmission system according to claim 1, wherein the receiver outputs a rate reduction command to the transmitter when the skew is not detected by the detector circuit, and
wherein the generator circuit reduces the rate of the second differential signal when the receiver outputs the rate reduction command.

11. A transmission method of a transmission system including a transmitter transmitting a first differential signal through a transmission path and a receiver, the transmission method comprising:
generating a second differential signal lower in baud rate than the first differential signal;
selecting between the second differential signal and the first differential signal to output the differential signal selected to the transmission path;
detecting a skew of the second differential signal transmitted and transferred through the transmission path; and
correcting a skew of the first differential signal transmitted and transferred through the transmission path, based on the detected skew.

12. The transmission method according to claim 11, further comprising setting a correction value responsive to the skew detected and correcting the skew of the first differential signal in accordance with the correction value.

13. The transmission method according to claim 12, further comprising outputting a correction complete notification when the correction value is set and outputting the first differential signal when the correction complete notification is output.

14. The transmission method according to claim 11, further comprising sensing the second differential signal and detecting the skew of the second differential signal when the second differential signal is sensed.

15. The transmission method according to claim 11, further comprising measuring a rate of the first differential signal and detecting a skew detection signal based on the rate.

16. The transmission method according to claim 11, further comprising outputting concurrently a correction command and the second differential signal when the correction command is output, and detecting the skew of the second differential signal when the correction command is output.

17. The transmission method according to claim 11, further comprising outputting a rate reduction command when the skew is not detected and reducing the rate of the second differential signal when the rate reduction command is output.
